(19) United States
(12) Patent Application Publication
(10) Pub. No.: US 2017/0186531 A1
(43) Pub. Date: Jun. 29, 2017

(54) COIL COMPONENT AND METHOD FOR MANUFACTURING SAME

(71) Applicant: Panasonic Intellectual Property Manament Co., Ltd, Osaka (JP)

(72) Inventors: MUTSUYASU OHTSUBO, Hyogo (JP); IKUYA WAKAMORI, Hyogo (JP)

(73) Assignee: Panasonic Intellectual Property Manament Co., Ltd., Osaka (JP)

(21) Appl. No.: 15/300,017

(22) PCT Filed: Jun. 30, 2015
(86) PCT No.: PCT/JP2015/003277

§ 371 Date: Sep. 28, 2016

(30) Foreign Application Priority Data
Jul. 7, 2014 (JP) 2014-139346

(51) Int. Cl. H01F 27/29; H01F 41/10; H01F 41/02; H01F 27/255; H01F 27/28

(52) U.S. Cl. CPC H01F 27/29; H01F 27/255; H01F 27/2823; H01F 41/0246; H01F 41/10

(57) ABSTRACT

A coil component of the present invention includes a magnetic core containing magnetic powder, a coil element embedded in the magnetic core and having an end projecting from the magnetic core, and a retaining member for retaining the end of the coil element. The retaining member has a main surface having a recess therein sinking toward the magnetic core. The retaining member has a ridge projecting from a bottom surface of the recess and extending linearly along the bottom surface. The ridge has a portion that intersects with the end of the coil element. The portion of the ridge is welded to the end of the coil element.

### TECHNICAL FIELD

The present invention relates to a coil component used for various electronic devices, and a method for manufacturing the coil component.

### BACKGROUND ART

In recent years, electronic components have been required to have small sizes and used with large currents as performance of electronic devices is highly developed. The electronic components include a coil component.

FIG. 17 is a perspective view of conventional coil component 5. Conventional coil component 5 includes coil element 1 made of an insulation-coated copper wire which is wound. An end of coil element 1 is welded to retaining members 3. Coil element 1 and retaining member 3 are pressure-molded integrally with mixed powder containing metallic magnetic powder and binding agent containing thermosetting resin, and partially embedded in magnetic core 2. Terminal 4 is formed by bending the end of coil element 1 and a portion of retaining member 3 projecting from a side surface of magnetic core 2.

PTL 1 is known as a prior art document relating to this application.

### CITATION LIST

### Patent Literature

PTL 1: Japanese Patent Laid-Open Publication No. 2013-191726

### SUMMARY

In order to provide coil component 5 shown in FIG. 17 with a small size, retaining member 3 has a small size. However, it is necessary to reduce the thickness of retaining member 3 to provide retaining member 3 with a small size. If the thickness is reduced, retaining member 3 may be distorted at welding. For instance, when retaining member 3 is welded to the end of coil element 1, retaining member 3 has a distortion. Especially, a resistance welding may cause a large distortion in retaining member 3. In the resistance welding, welding electrodes sandwich the end of coil element 1 and retaining member 3 between the electrodes to press. When the welding electrodes apply a pressure, retaining member 3 is elongated in a direction perpendicular to a direction in which the end of coil element 1 extends, thereby causing distortion. The distortion of retaining member 3 may be an obstacle for a metallic mold to perform proper molding when a magnetic material and retaining member 3 are pressure molded. Alternatively, it may be considered to increase a clearance of a metallic mold, but the consideration is undesirable because a leak of magnetic materials occurs at the pressure molding, and thus causes deterioration in productivity.

In view of the above problem in conventional coil component 5, a coil component according to the present invention includes a magnetic core containing binding agent and magnetic powder mixed into the binding agent, a coil element embedded in the magnetic core, and a retaining member for retaining an end of the coil element. The end of the coil element projects from the magnetic core. The retaining member has a recess therein sinking toward the magnetic core. The retaining member has a ridge projecting from a bottom surface of the recess and extending linearly along the bottom surface. The ridge has a portion intersecting with the end of the coil element, and is welded to the end of the coil element at the portion.

The above configuration prevents distortion from occurring in the retaining member, and provides the coil component with high productivity even if the coil component has a small size.

### BRIEF DESCRIPTION OF DRAWINGS

FIG. 1 is an exploded perspective view of a coil component in accordance with an exemplary embodiment of the present invention.

FIG. 2 is a perspective view of the coil component in accordance with the embodiment.

FIG. 3 is a cross-sectional view of the coil component along line III-III shown in FIG. 2.

FIG. 4 is a cross-sectional view of the coil component along line IV-IV shown in FIG. 2.

FIG. 5 is a side view of the coil component shown in FIG. 2 for illustrating a retaining member.

FIG. 6 is a perspective view of a coil component in accordance with an exemplary embodiment.

FIG. 7 is a side view of the coil component shown in FIG. 6 for illustrating a retaining member.

FIG. 8 is a perspective view of a coil component in accordance with an exemplary embodiment.

FIG. 9 is a side view of the coil component shown in FIG. 8 for illustrating a retaining member.

FIG. 10 shows a method for manufacturing the coil component shown in FIG. 2.

FIG. 11 shows the method for manufacturing the coil component shown in FIG. 2.

FIG. 12 shows the method for manufacturing the coil component shown in FIG. 2.

FIG. 13 shows the method for manufacturing the coil component shown in FIG. 2.

FIG. 14 shows the method for manufacturing the coil component shown in FIG. 2.

FIG. 15 shows the method for manufacturing the coil component shown in FIG. 2.

FIG. 16 shows the method for manufacturing the coil component shown in FIG. 6.

FIG. 17 is a perspective view of a conventional coil component.

### DETAIL DESCRIPTION OF PREFERRED EMBODIMENTS

### Exemplary Embodiment 1

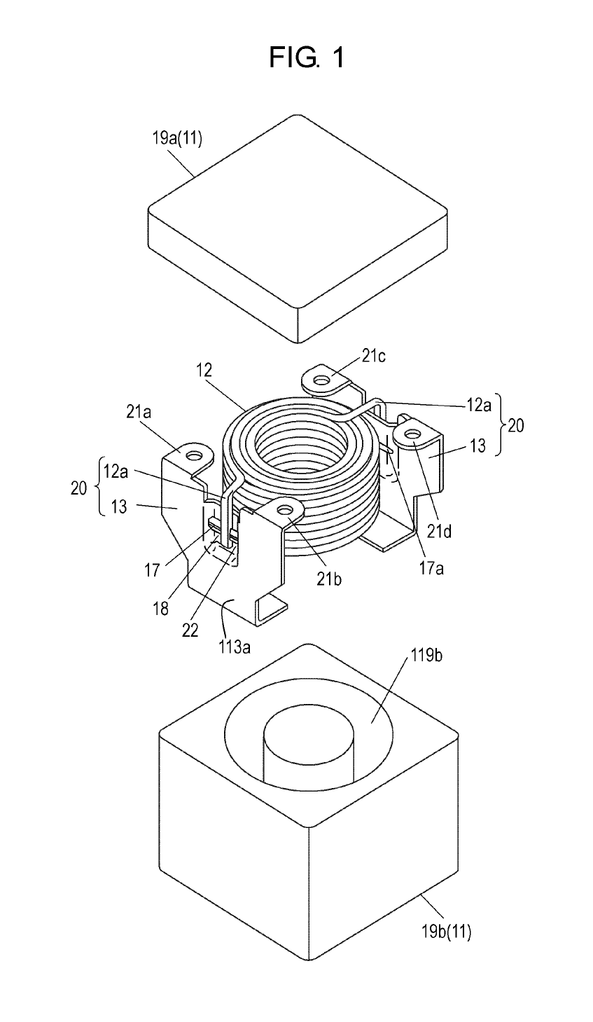

FIG. 1 is an exploded perspective view of coil component 10 in accordance with Exemplary Embodiment 1.

Coil component 10 in accordance with the present embodiment includes magnetic core 11 containing metallic magnetic powder and binding agent containing thermosetting resin, coil element 12 formed by winding a lead wire helically, and retaining member 13 for electrically connecting to an external terminal. A winding part of coil element 12 is embedded in magnetic core 11 while and end 12a of coil element 12 is exposed from magnetic core 11. End 12a of coil element 12 is electrically connected to retaining member 13 by welding. Retaining member 13 is partially embedded and fixed in magnetic core 11.

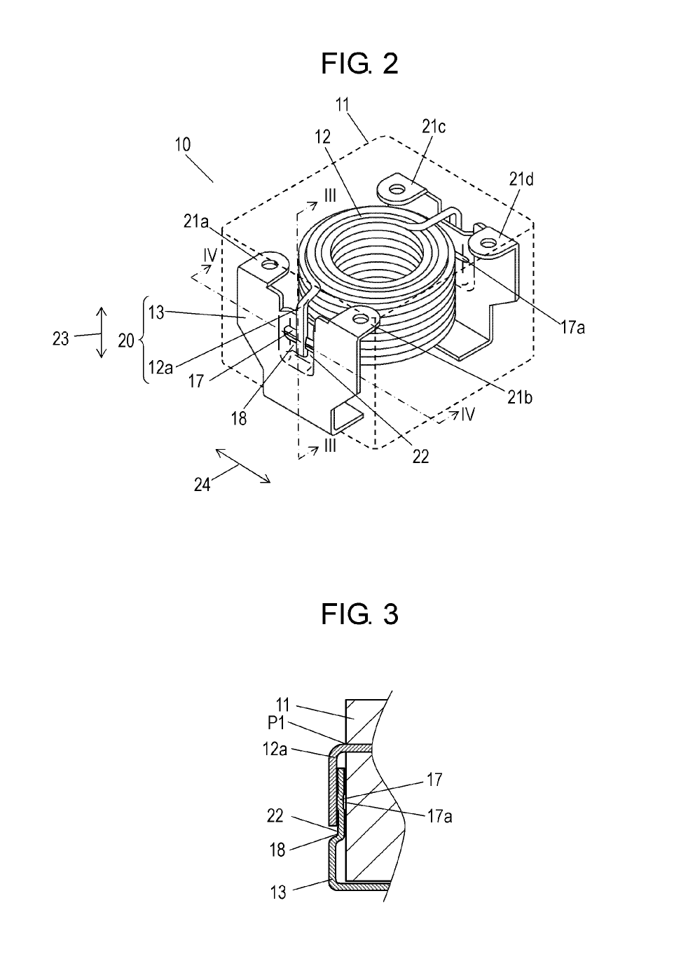

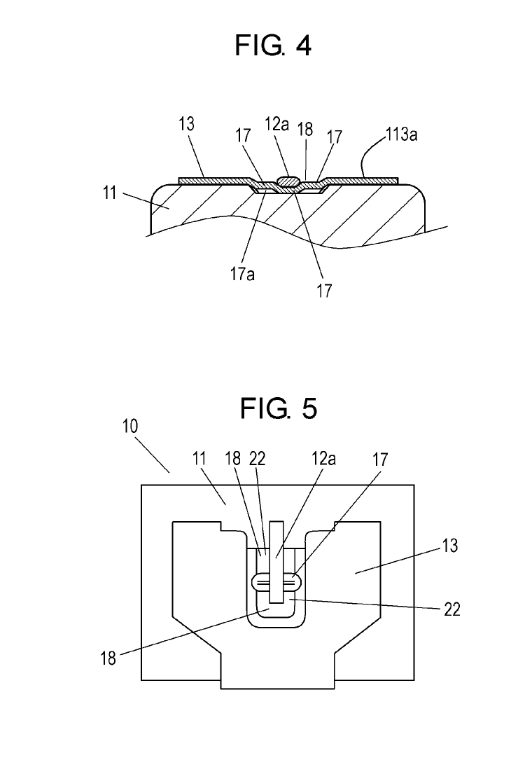

FIG. 2 is a perspective view of coil component 10 seeing through magnetic core 11. The outline of magnetic core 11 is illustrated by the broken line. FIG. 3 is a cross-sectional view of coil element 12 along line III-III shown in FIG. 2 in which retaining member 13 is welded to end 12a of coil element 12. FIG. 4 is a cross-sectional view of the coil component along line IV-IV shown in FIG. 2 for illustrating retaining member 13 welded to end 12a of coil element 12. FIG. 5 is a side view of the coil component shone in FIG. 2 for illustrating retaining member 13.

Magnetic core 11 shown in FIG. 2 includes pressurized powder body 19a and pressurized powder body 19b shown in FIG. 1.

The binding agent containing thermosetting resin is mixed with metallic magnetic powder while the thermosetting resin is not fully cured, and pressure molded at a molding pressure of about 1 ton/cm² to form pressurized powder body 19a and pressurized powder body 19b.

Pressurized powder body 19b has a rectangular columnar shape having therein accommodating part 119b for accommodating coil element 12 therein. Pressurized powder body 19a has a lid shape to be put on pressurized powder body 19b. Coil element 12 is accommodated in accommodating part 119b serving as a hollow provided in pressurized powder body 19b. Pressurized powder bodies 19a and 19b are pressure molded again while coil element 12 is disposed between pressurized powder body 19a and pressurized powder body 19b, thereby providing magnetic core 11. At this moment, the second pressure molding is carried out at a molding pressure of about 5 ton/cm² which is larger than the molding pressure at the first pressure molding. The thicknesses of pressurized powder body 19a and pressurized powder body 19b after the second pressure molding is smaller than thicknesses of pressurized powder body 19a and pressurized powder body 19b before the second pressure molding. That is, the density of pressurized powder body 19a and pressurized powder body 19b after the second pressure molding is larger than the density of pressurized powder body 19a and pressurized powder body 19b before the second pressure molding. The second pressure molding allows coil element 12 to be embedded in pressurized powder body 19a and pressurized powder body 19b, thereby providing magnetic core 11 in which end 12a of the coil element 12 and retaining member 13 project from the boundary between pressurized powder body 19a and pressurized powder body 19b. Subsequently, the thermosetting resin contained in magnetic core 11 is fully cured by heat-treatment.

Coil element 12A is formed by winding a copper wire with a surface coated with insulation to have a coil form. In accordance with the embodiment, coil element 12 has a diameter of 0.3 mm. The insulation coating the surface of end 12a of coil element 12 is removed previously by the time when end 12a is electrically connected to ridge 17 by welding described later. End 12a of coil element 12 is pressed to have a flat shape with a thickness of about 0.2 mm.

In accordance with the embodiment, a copper plate with a thickness of about 0.15 mm is punched to form retaining member 13. Two retaining members 13 extending along two side surfaces of magnetic core 11 opposite to each other are bent along a lower surface of the magnetic core 11. One retaining member 13 out of two retaining members 13 has projecting portions 21a and 21b projecting from both sides of an end of retaining member 13. Another retaining member 13 out of two retaining members 13 has projecting portions 21c and 21d projecting from both sides of an end of retaining member 13. Projecting portions 21a, 21b, 21c, and 21d are embedded and fixed in magnetic core 11.

A surface of retaining member 13 projecting from magnetic core 11 may be coated with solder by solder dipping, if necessary. Retaining member 13 constitutes terminal part 20 together with end 12a of coil element 12, and is connected to an external terminal.

Retaining member 13 has recess 18 therein. Recess 28 is formed such that an area of retaining member 13 including a portion of retaining member 13 where retaining member 13 and end 12a of coil element 12 overlap sinks toward magnetic core 11 from the remaining area of retaining member 13. Retaining member 13 has main surface 113a having recess 18 formed therein. In accordance with the embodiment, a depth of recess 18 is about 0.2 mm. Retaining member 13 has ridge 17 projecting from bottom surface 22 of recess 18.

As shown in FIG. 5, ridge 17 extends linearly as to intersect with an extending direction in which end 12a of coil element 12 extends. Recess 18 is embossed from a back surface of recess 22 opposite to bottom surface 22 to form ridge 17. Upon being welded by resistance welding while ridge 17 intersects with end 12a of coil element 12, ridge 17 is electrically connected to end 12a of coil element 12 by the welding.

A length of ridge 17 is larger than a width of end 12a of coil element 12. In accordance with the embodiment, ridge 17 has a height of 0.1 mm projecting from bottom surface 22.

According to the embodiment, as shown in FIGS. 2 and 3, recess 18 is embossed from the back surface of recess 18 opposite to bottom surface 22 to form ridge 17. Groove 17a is formed in the back surface of ridge 17 along the shape of ridge 17 by the embossing. Since groove 17a extends along the shape of ridge 17 in the back surface of ridge 17, welding pressure easily distorts and crushes ridge 17 when ridge 17 is welded to end 12a of coil element 12 by resistance welding. This prevents projecting portions 21a, 21b, 21c, and 21d from expanding in direction 24 of retaining member 13, thereby reducing a clearance between a die and retaining member 13.

As a result, even if being made of soft material with high conductivity, such as copper, retaining member 13 can be thin, thereby providing coil component 10 with a small size.

Direction 23 shown in FIG. 2 is perpendicular to the lower surface of coil component 10 (magnetic core 11) while direction 24 is parallel to the lower surface of coil component 10 and the side surface of magnetic core 11 accommodating retaining member 13.

According to the embodiment, a cross section of ridge 17 in a direction perpendicular to the direction in which ridge 17 extends preferably has a projection shape tapering from a root portion to a tip end of ridge 17. The cross section of ridge 17 preferably has, e.g. a triangular shape, a circular arc shape, and a trapezoidal shape. The above shape of ridge 17 allows a current to concentrate and flow into a top of ridge 17 when ridge 17 is welded by resistance welding. Therefore, end 12a of coil element 12 can be welded to retaining member 13 stably.

According to the embodiment, when retaining member 13 is distorted, projecting portions 21a and 21b may be distorted in direction 24 in which the projecting portions are separated from each other and caught by a die at the second pressure welding. Further, projecting portions 21c and 21d may be distorted similarly. To solve this problem, ridge 17 has the projecting cross section, and extends linearly in the direction in which ridge 17 intersects with end 12a of coil element 12. Thus, a direction of stress crushing and widening ridge 17 can be directed in direction 23. This configuration easily elongates ridge 17 in direction 23, and prevents projecting portions 21a, 21b, 21c, and 21d of retaining member 13 from being distorted in direction 24.

Accordingly, ridge 17 intersecting perpendicularly with end 12a of coil element 12 in the direction in which end 12a of coil element 12 extends further prevents projecting portions 21a, 21b, 21c, and 21d of retaining member 13 from being distorted in the direction 24.

As shown in FIG. 4, in accordance with the embodiment, ridge 17 projecting from bottom surface 22 of recess 18 is provided in recess 18.

Since ridge 17 is provided in recess 18, the distortion caused when ridge 17 deforms can hardly transmit to main surface 113a of the retaining member 13 around recess 18.

Further, the height of ridge 17 projecting from bottom surface 22 of recess 18 may be not larger than two thirds of the depth of recess 18. This configuration prevents the distortion caused when ridge 17 deforms from transmitting to main surface 113a of the retaining member 13.

### Exemplary Embodiment 2

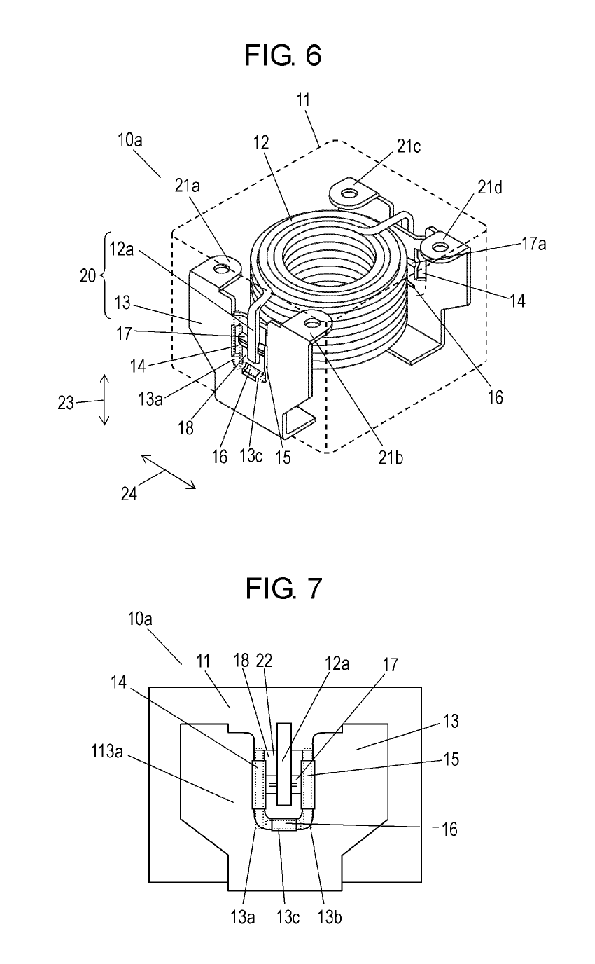

FIG. 6 is a perspective view of coil component 10a in accordance with Exemplary Embodiment 2. A broken line in FIG. 6 denotes the outline of magnetic core 11. FIG. 7 is a side view of the coil component for showing retaining member 13 shown in FIG. 6.

In FIGS. 6 and 7, components identical to those of coil component 10 according to Embodiment 1 shown in FIGS. 1 to 5 are denoted by the same reference numerals.

As shown in FIG. 7, in coil component 10a, retaining member 13 has slits 14 slit 15 passing through retaining member 13. End 12a of coil element 12 and ridge 17 are disposed between slits 14 and 15.

Since end 12a of coil element 12 and ridge 17 are disposed between slits 14 and 15, coil component 10a reduces stress which is caused when retaining member 13 is welded to end 12a of coil element 12 by resistance welding and which transmits in direction 24 of retaining member 13. In coil component 10a according to the present embodiment, slit 14 and slit 15 have longer sides parallel to each other, and have rectangular shapes having lengths in direction 23 of about 1.2 mm and lengths in direction 24 of about 0.3 mm. A distance between slit 14 and slit 15 is about 1 mm.

Retaining member 13 further has slit 16 passing through retaining member 13. Slit 16 is provided in an area which is between slit 14 and slit 15 and which extends in a direction in which end 12a of coil element 12 extends. Slit 16 is provided in the area extending in the direction in which end 12a of coil element 12 extends. Slit 16 reduces the distortion of retaining member 13 in direction 23 which is caused when retaining member 13 is welded to end 12a of coil element 12 by resistance welding.

In accordance with the present embodiment, slit 16 has a rectangular shape having a length in direction 24 of about 0.6 mm and a length in direction 23 of about 0.3 mm. A distance between slit 16 and slit 14 and a distance between slit 16 and slit 15 are about 0.5 mm.

As shown in FIG. 7, retaining member 13 has step portion 13a (inside an area surrounded by a broken line), step portion 13b (inside an area surrounded by a broken line), and step portion 13c (inside an area surrounded by a broken line) which are connected to main surface 113a of retaining member 13 and bottom surface 22 of recess 18. Step portions 13a, 13b and 13c constitute a step around recess 18. End 12a of the coil element 12 and ridge 17 are disposed between step portions 13a and 13b opposite to each other.

Step portion 13c is provided in an area that is between slit 14 and slit 15 and that extends in the direction in which end 12a of coil element 12 extends. Slits 14, 15, and 16 passes in along step portions 13a, 13b, and 13c, respectively, thereby forming recess 18 easily.

### Exemplary Embodiment 3

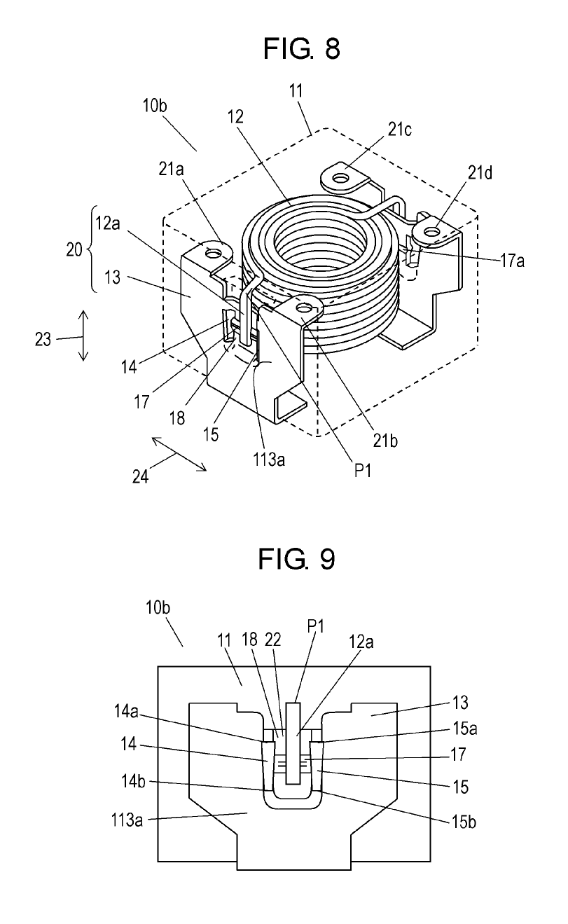

FIG. 8 is a perspective view of coil component 10b in accordance with Exemplary Embodiment 3. A broken line in FIG. 8 denotes the outline of magnetic core 11. FIG. 9 is a side view of the coil component for illustrating retaining member 13 shown in FIG. 8. In FIGS. 8 and 9, components identical to those of coil components 10 and 10a according to Embodiments 1 and 2 are denoted by the same reference numerals. Coil component 10b according to Embodiment 3 is different from coil component 10a according to Embodiment 2 in that widths of portions of slit 14 and slit 15 in a direction perpendicular to a direction in which slit 14 and slit 15 slenderly extend change depending on the positions of the portions.

The widths of slit 14 and slit 15 in the direction in which slit 14 and slit 15 extend will be described with referring to FIG. 9.

Slits 14 has both end portions 14a and 14b in direction 23 in which slit 14 slenderly extends. End portion 14a, out one of the both end portions, is located close to position P1 (see FIGS. 9 and 3) at which end 12a of coil element 12 projects from magnetic core 11. End portion 14b, the other of the both ends portion, is located farther from position P1 than end portion 14a is. The width of end portion 14a is larger than the width of end portion 14b. This configuration allows solder to easily enter in slit 14 when retaining member 13 is dipped into the solder, thereby increases the strength of terminal area 20.

That is, slit 14 has end portion 14a which has a width larger than that of end portion 14b. A distance between end portion 14b and position P1 at which end 12a of coil element 12 projects from magnetic core 11 is larger than a distance between end portion 14a and position P1.

The width of slit 14 increases monotonically from end portion 14b, the other of the both end portions, to portion 14a, one of the both end portions. This configuration allows solder to enter in slit 14 more easily, thereby increasing strength of terminal area 20.

According to the present embodiment, the width of slit 14 is 0.3 mm at end portion 14a, one of the both end portions located close to position P1 at which end 12a of coil element 12 projects from magnetic core 11, and the width of slit 14 is 0.2 mm at end portion 14b, the other of the both end portions.

Slit 15 has the same shape as slit 14.

That is, slit 15 has both end portions 15a and 15b of in direction 23 in which slit 15 slenderly extends. End portion 15a, one of the both end portions, is located close to position P1 (see FIGS. 9 and 3) at which end 12a of coil element 12 projects from magnetic core 11. End portion 15b, the other of the both end portions, is located farther from position P1 than end portion 15a is. A width of end portion 15a is larger than that of end portion 15b. This configuration allows solder to easily enter into slit 15 when retaining member 13 is dipped into the solder, thereby increasing strength of terminal area 20.

That is, slit 15 has end portion 15a which has a width larger than that of end portion 15b. A distance between end portion 15b and position P1 at which end 12a of coil element 12 projects from magnetic core 11 is larger than a distance between end portion 15a and position P1.

The width of slit 15 increases monotonically from end portion 15b, the other of the both end portions, to end portion 15a, one of the both end portions. This configuration allows solder to enter into slit 15 more easily, thereby increasing strength of terminal area 20.

According to the exemplary embodiment, the width of slit 15 is 0.3 mm at end portion 15a, one of the both end portions located close to position P1 at which end 12a of coil element 12 projects from magnetic core 11, and the width of slit 15 is 0.2 mm at end portion 15b, the other of the both end portions. This configuration allows solder to enter into slit 15 more easily, thereby increasing strength of terminal area 20.

(Method for Manufacturing Coil Component 10 in Accordance with Embodiment 1)

A method for manufacturing coil component 10 in accordance with Embodiment 1 shown in FIG. 2 will be described below.

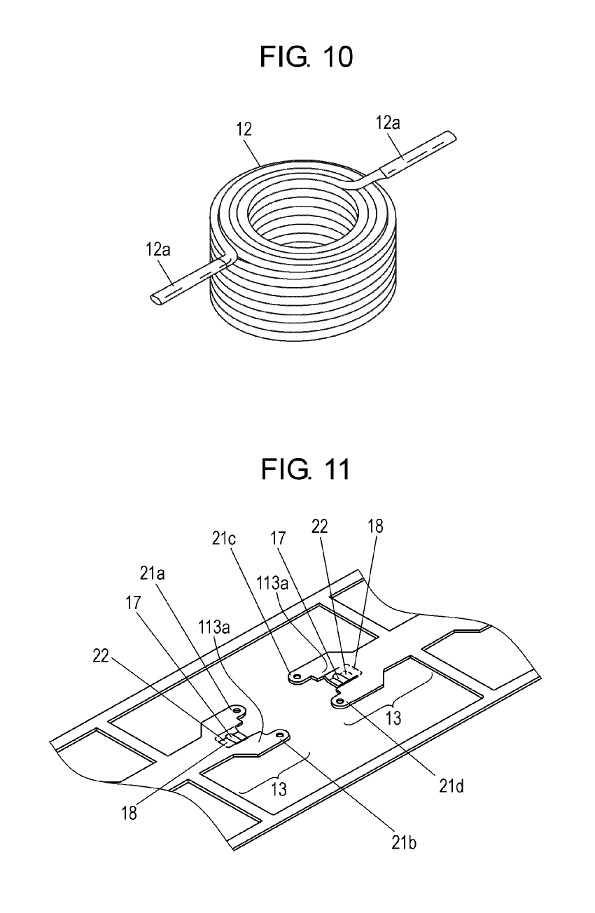

FIG. 10 is a perspective view of coil element 12 to be embedded in magnetic core 11 of coil component 10 in accordance with Embodiment 1. As shown in FIG. 10, a copper wire with a diameter of 0.3 mm having a surface coated with insulation is wound helically to provide coil element 12. Two ends 12a of coil element 12 extend in directions opposite to each other. The insulation coating end 12a of coil element 12 therewith is removed before end 12a is electrically connected to retaining member 13. End 12a of coil element 12 is pressed to have a flat shape having a thickness in the pressing direction of about 0.2 mm. Since being pressed to have the flat shape, end 12a of coil element 12 is prevented from projecting outward from recess 18, thereby preventing overall dimensions of coil component 10 from increasing.

In the case that coil element 12 is made of a copper wire having a small diameter, end 12a of coil element 12 may necessarily be pressed.

FIG. 11 is a perspective view of retaining member 13 connected to a hoop. As shown in FIG. 11, a copper plate is punched by using a die to provide retaining member 13 connected to a hoop. At this moment, retaining member 13 is pressed to form recess 18 sinking from main surface 113a of retaining member 13 by a depth of about 0.2 mm. Then, recess 18 is embossed from a back surface of recess opposite to bottom surface 22 to form ridge 17 on bottom surface 22 of recess.

In accordance with Embodiment 1, a height of ridge 17 projecting from bottom surface 22 of recess 18 is 0.1 mm, and ridge 17 has a linear shape which intersects perpendicularly with end 12a of coil element 12. Ridge 17 may be formed by pressing simultaneously when recess 18 is pressed.

Groove 17a extending linearly (see FIGS. 1 and 2) is formed in a back surface of ridge 17 by the above embossing. Further, two retaining members 13 have respective end portions facing each other. Projecting portions 21a and 21b are provided at both sides of one of the respective end portions of two retaining members 13. Projecting portions 21c and 21d are provided at both sides of another of the respective end portions of two retaining members 13. Projecting portions 21a, 21b, 21c, and 21d are embedded in magnetic core 11 and fixed when magnetic core 11 is subjected to the second-pressure molding described later.

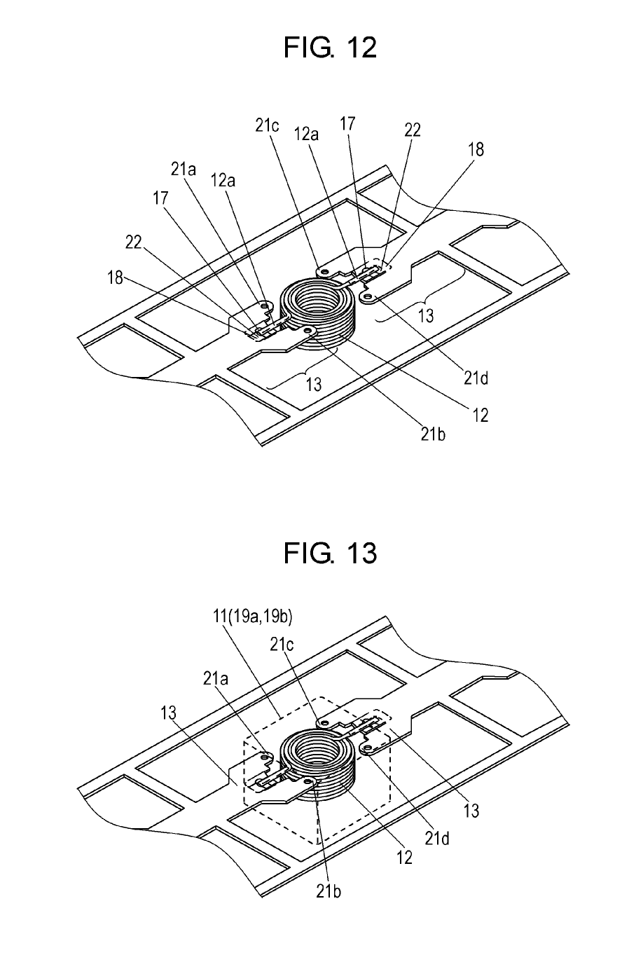

FIG. 12 is a perspective view of coil element 12 having end 12a fixed to retaining member 13 shown in FIG. 11.

As shown in FIG. 12, end 12a of coil element 12 is put into recess 18, and end 12a of coil element 12 and ridge 17 cross and are placed on each other. Then, coil element 12 is fixed to retaining member 13 by resistance welding.

FIG. 13 is a perspective view of magnetic core 11 in which coil element 12 and projecting portions 21a, 21b, 21c, and 21d of two retaining members 13 shown in FIG. 12 are embedded. In FIG. 13, the outline of magnetic core 11 is denoted by a broken line. A method for manufacturing magnetic core 11 will be described below.

First, binding agent containing thermosetting resin is mixed to metallic magnetic powder to provide mixed material. The mixed material is dried such that the thermosetting resin is not fully cured, and then, crushed into particles to provide magnetic material powder. The magnetic material powder is pressure molded at about 1 ton/cm² to form pressurized powder body 19a and pressurized powder body 19b shown in FIG. 1.

Next, pressurized powder body 19a is placed on pressurized powder body 19b such that coil element 12 and projecting portions 21 shown in FIG. 12 are disposed between pressurized powder bodies 19a and 19b, and then, pressurized powder bodies 19a and 19b are unified by the second pressure molding. The second pressure molding is carried out at about 5 ton/cm².

The above processes provides magnetic core 11 denoted by the broken line shown in FIG. 13. Coil element 12 and projecting portions 21a, 21b, 21c, and 21d are embedded in magnetic core 11. Subsequently, magnetic core 11 is heat-treated at 180° C. to fully cure the thermosetting resin contained in pressurized powder bodies 19a and 19b.

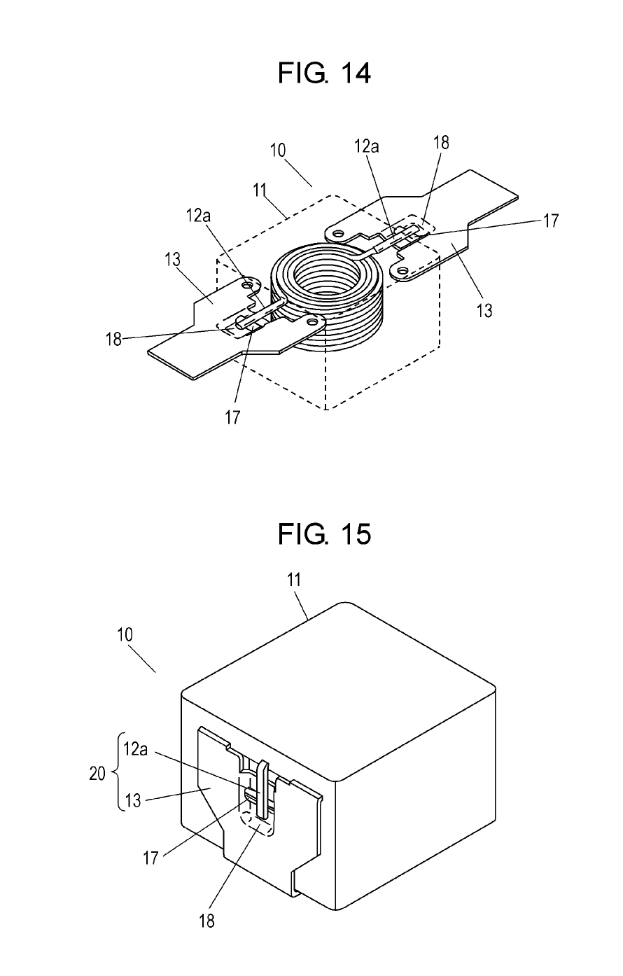

FIG. 14 is a perspective view of retaining member 13 after retaining member 13 shown in FIG. 13 is separated from a hoop. A broken line denotes the outline of magnetic core 11.

As shown in FIG. 14, two retaining members 13 fixed to magnetic core 11 are separated from the hoop to provide individual pieces. End 12a of retaining member 13 and coil element 12 are coated with a flux and then dipped into solder. As a result, retaining member 13 and end 12a of coil element 12 are connected with solder.

The above processes provide coil component 10.

FIG. 15 is a perspective view of coil component 10 in which two retaining members 13 shown in FIG. 14 extend along two side surfaces of magnetic core 11, and bent on the lower surface of coil component 10.

As shown in FIG. 15, retaining member 13 which is separated into an individual piece shown in FIG. 14 is cut to have a predetermined length, and the back surface of recess 18 opposite to bottom surface 22 of recess 18 is bent along the side surface of the magnetic core 11.

Then, retaining members 13 are bent toward the lower surface of magnetic core 11 to provide coil component 10 shown in FIG. 15. A recess may be formed in the side surface of magnetic core 11 to have recess 18 of the retaining member 13 fit into the recess.

(Method for Manufacturing Coil Component 10s in Accordance with Embodiment 2)

Next, a method for manufacturing coil component 10a in accordance with Exemplary Embodiment 2 shown in FIG. 6 will be described below.

A difference between the manufacturing methods according to Embodiments 1 and 2 is that whether a slit is provided in retaining member 13 or not.

Hereinafter, description about the same manufacturing method as Embodiment 1 is omitted.

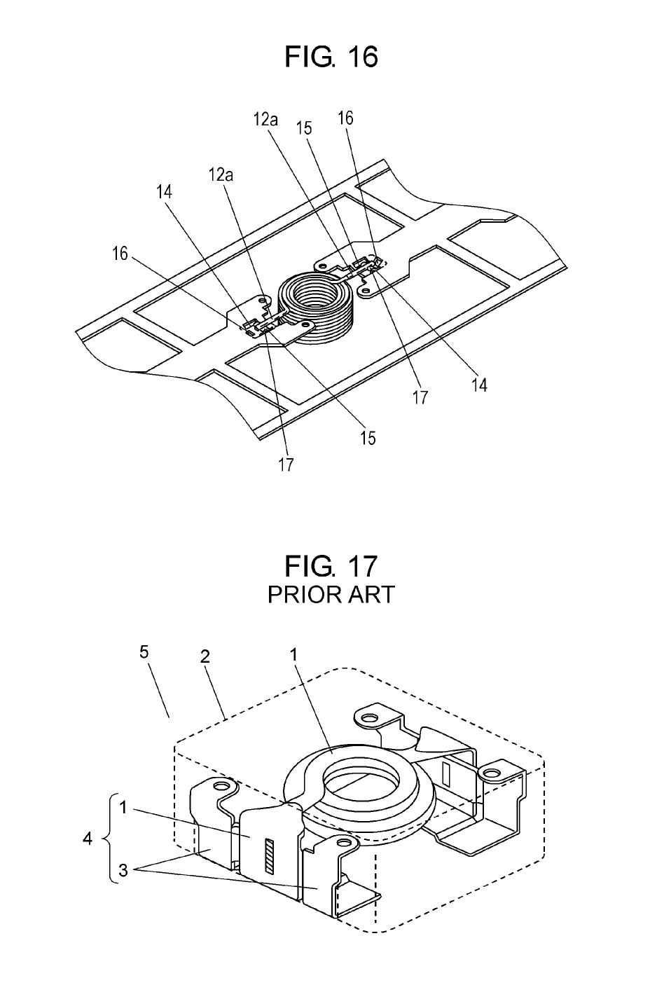

FIG. 16 is a perspective view of retaining member 13 having slits 14, 15, and 16 provided in retaining member 13 in FIG. 12.

As shown in FIG. 16, retaining member 13 in accordance with Embodiment 2 has slits 14 and 15 such that end 12a of coil element 12 and ridge 17 are disposed between slits 14 and 15. Slit 16 is provided in an area that is between slit 14s and 15 and extends in the direction in which end 12a of coil element 12 extends.

Slits 14, 15, and 16 are formed by punching retaining member 13 while being connected to the hoop shown in FIG. 11.

As shown in FIGS. 6 and 7, slit 14 is formed in along step portion 13a, slit 15 is formed in along step portion 13b, and slit 16 is formed in along step portion 13c, thereby allowing recess 18 to be formed easily.

In the method for manufacturing coil component 10a according to Embodiment 2 shown in FIG. 6, coil component 10b according to Embodiment 3 shown in FIG. 8 can be formed by adjusting a slit to be punched in shape suitably when retaining member 13 connected to the hoop is punched.

### INDUSTRIAL APPLICABILITY

A coil component in accordance with the present invention can reduce clearance between a die and a retaining member even if having a small size, and is useful as a coil component with high productivity.

### REFERENCE MARKS IN THE DRAWINGS

10, 10a, 10b coil component
11 magnetic core
12 coil element
12a end of coil element
13 retaining member
13a step portion (first step portion)
13b step portion (second step portion)
13c step portion (third step portion)
14 slit (first slit)
14a end portion (second portion)
14b end portion (first portion)
15 slit (second slit)
15a end portion (fourth portion)
15b end portion (third portion)
16 slit (third slit)
17 ridge
17a groove
18 recess
19a pressurized powder body
19b pressurized powder body
20 terminal area
21a projecting portion
21b projecting portion
21c projecting portion
21d projecting portion
22 bottom surface

1. A coil component comprising:
a magnetic core containing magnetic powder;
a coil element embedded in the magnetic core, the coil element having has an end projecting from the magnetic core; and
a retaining member for retaining the end of the coil element,
wherein the retaining member has a main surface having a recess therein sinking toward the magnetic core,
wherein the retaining member has a ridge projecting from a bottom surface of the recess and extending linearly along the bottom surface, and
wherein the ridge has a portion that intersects with the end of the coil element, and is welded to the end of the coil element at the portion of the ridge.

2. The coil component according to claim 1, wherein the ridge is provided in the recess.

3. The coil component according to claim 1, wherein the retaining member has a first slit and a second slit arranged such that the end of the coil element and the ridge are provided between the first slit and the second slit.

4. The coil component according to claim 3,
wherein the recess has a first step portion and a second step portion which are connected to the main surface of the retaining member and the bottom surface of the recess,
wherein the first slit passes in along the first step portion of the recess, and
wherein the second slit passes in along the second step portion of the recess.

5. The coil component according to claim 3,
wherein the first slit has a first portion and a second portion, the first portion of the first slot having a first width, the second portion of the first slit having a second width larger than the first width,
wherein a distance between a position at which the end of the coil element projects from the magnetic core and the first portion of the first slit is larger than a distance between the position and the second portion of the first slit,
wherein the second slit has a third portion and a fourth portion, the third portion of the second slit having a third width, the fourth portion of the second slit having a fourth width larger than the third width, and
wherein a distance between the position and the third portion of the second slit is larger than a distance between the position and the fourth portion of the second slit.

6. The coil component according to claim 5,
wherein the first portion of the first slit includes one of both ends of the first slit, and the second portion includes another of the both ends of the first slit,
wherein a width of the first slit monotonically increases from the first portion to the second portion of the first slit,
wherein the third portion of the second slit includes one of both ends of the second slit, and the fourth portion includes another of the both ends of the second slit, and
wherein a width of the second slit monotonically increases from the third portion to the fourth portion of the second slit.

7. The coil component according to claim 3, wherein the retaining member has a third slit between the first slit and the second slit, the third slit extends in a direction in which the end of the coil element extends.

8. The coil component according to claim 7,
wherein the recess has a step portion connected to the main surface of the retaining member and the bottom surface of the recess, and
wherein the third slit passes in along the step portion of the recess.

9. A method for manufacturing a coil component, comprising:
providing a coil element including a wound lead wire having an end;
providing a retaining member made of a flat metal plate having a recess therein, the retaining member having a ridge projecting from a bottom surface of the recess and extending linearly along the bottom surface;
disposing the retaining member and the coil element to allow the ridge to have a portion intersecting with the end of the coil element;
welding the portion of the ridge with the end of the coil element; and
pressure molding a magnetic core made of a magnetic material while the coil element is embedded in the magnetic core.

10. The method according to claim 9, further comprising bending the retaining member.

11. The method according to claim 9, wherein the retaining member has a first slit and a second slit arranged such that the end of the coil element and the ridge are disposed between the first slit and the second slit.

12. The method according to claim 11,
wherein the first slit passes in along a first step portion of the recess connected to the main surface of the retaining member and the bottom surface of the recess, and
wherein the second slit passes in along a second step portion of the recess connected to the main surface of the retaining member and the bottom surface of the recess.

13. The method according to claim 11, wherein the retaining member has a third slit between the first slit and the second slit, the third slit extending in a direction in which the end of the coil element extends.

14. The method according to claim 13, wherein the third slit passes in along a third step portion of the recess connected to the main surface of the retaining member and the bottom surface of the recess.
